(19) United States
(12) Patent Application Publication
(10) Pub. No.: US 2003/0235205 A1
(43) Pub. Date: Dec. 25, 2003

(54) Ethernet passive optical network system

(76) Inventors: Jae-Yeon Song, Songnam-shi (KR); Jin-Hee Kim, Suwon-shi (KR); A-Jung Kim, Seoul (KR); Min-Hyo Lee, Suwon-shi (KR); Se-Youn Lim, Seoul (KR); Su-Hyung Kim, Seoul (KR)

Correspondence Address: CHA & REITER, LLC, 210 ROUTE 4 EAST, PARAMUS, NJ, 07652, US

(21) Appl. No.: 10/465,180

(22) Filed: Jun. 19, 2003

(30) Foreign Application Priority Data
Jun. 24, 2002 (KR) 2002-35470

(51) Int. Cl. H04J 3/22

(52) U.S. Cl. 370/466

(57) ABSTRACT

Ethernet Passive Optical Network (PON) system is provided and includesan Optical Line Termination (OLT) and a plurality of Optical Network Units (ONUs) connected to the OLT, and the system implements a Peer-to-Peer (P2P) transmission between ONU-side objects controlled by the OLT. A PON tagging Ethernet frame for the P2P transmission includes a Destination Address (DA) field, a Source Address (SA) field, a mode field indicating an emulation mode, and a PHY_ID field indicating identifiers of the ONU-side objects, and a data field. The OLT further includes: a multiplexing layer for transmitting a received PON tagging Ethernet frame to an upper layer over a logic port associated with a corresponding PHY_ID field, and a bridging function layer for converting information of the PHY_ID field into PHY_ID information corresponding to a destination ONU-side object by referring to the DA field when an emulation mode of a frame received through the logic port is the P2P transmission mode and for transmitting the converted PHY_ID information to a corresponding ONU through a logic port associated with the converted PHY_ID information.

### CLAIM OF PRIORITY

This application claims priority to an application entitled “ETHERNET PASSIVE OPTICAL NETWORK SYSTEM,” filed in the Korean Intellectual Property Office on Jun. 24, 2002 and assigned Serial No. 2002-35470, the contents of which are hereby incorporated by reference.

### BACKGROUND OF THE INVENTION

1. Field of the Invention

The present invention relates to a Passive Optical Network (PON) system, and more particularly to an Ethernet PON (EPON) system.

2. Description of the Related Art

In general, a PON system has a configuration where a single Optical Line Termination (OLT) is connected to a plurality of ONUs (Optical Network Units) over Optical Distribution Networks (ODN). In this configuration, all nodes are distributed in the form of a tree structure.

An exemplary well known PON system is in the form of Asynchronous Transfer Mode (ATM)—PON. Currently, point-to-point gigabit Ethernet technology and MAC technology of the ATM-PON have been standardized which are described in an IEEE 802.3z and an ITU-T (International Telecommunication Union-T) G.983. 1. One example of the MAC technology of the ATM-PON is described in U.S. Pat. No. 5,978,374 issued on 2 Nov. 1999, entitled “PROTOCOL FOR DATA COMMUNICATION OVER A POINT-TO-MULTIPOINT PASSIVE OPTICAL NETWORK”, by Gigad Ghaib et al., which is incorporated herein by reference.

FIG. 1 is a view illustrating a relationship between the IEEE 802.3 Ethernet and the IEEE 802.1D bridge.

The development of the IEEE 802.1D standard is based on a shared media in which an Ethernet media allows one physical transmission media to be shared with a plurality of communication stations, such that an Ethernet frame received from a user terminal from various areas and connected to a bridge is transmitted to all user terminals in other areas connected to the bridge, as shown in FIG. 1. As bridge receives all Ethernet frames according to their individual characteristics of the shared media, the bridge receiving a frame at the individual ports stores the destination addresses and the source addresses in an address table. As a result, it is possible for the bridge to learn addresses of every port. The bridge receiving a frame after learning the addresses of every port transmits the received frame to only a port to which a destination address is assigned, but does not transmit the frame to other ports other than the port with the destination address, thereby reducing the number of data collisions, which is undesirable in the shared media. .

Meanwhile the bridge is configured to receive a frame under the following three conditions.

(1) The first condition is provided on the assumption that the bridge does not search for the destination address of a received frame from a plurality of addresses stored in the address table. Instead, if there is no source address in the address table, or the bridge does not receive a frame associated with the source address (i.e., if the bridge receives an unpracticed address) the bridge transmits the frame to all ports other than the port receiving the unpracticed address as it cannot determine which one of ports will be used for frame transmission.

(2) The second condition is provided on the assumption that the port assigned to an address contained in the address table is the same as the port receiving a frame even though the address is found in the table. As such, a received frame can be discarded under the second condition. For example, referring to FIG. 1, in the case where a user terminal “a” of an area “A” transmits an Ethernet frame to another user terminal “b” contained in the same area “A”, the Ethernet frame is also transmitted to the bridge as sell. However, because the port to which a destination address of the Ethernet frame is assigned is the same as a port to which the Ethernet frame is received, the bridge discards the Ethernet frame without transmitting it. The second condition is intended to reduce the unnecessary amount of traffic because the frame has already been transmitted to a destination address.

(3) The third condition is provided on the assumption that a destination address is found in the address table, but is not assigned to a port receiving a frame. In this case, the bridge transmits the frame to the port assigned to the destination address in the address table.

FIG. 2 is a block diagram illustrating a conventional PON system. As shown, the PON system includes an Optical Line Termination (OLT) 110, a plurality of Optical Network Units (ONUs) 132, 134 and 136, and an Optical Distribution Network (ODN) 120.

The OLT 110 is located on a tree structure route and plays an important role in providing each subscriber (i.e., each user) an access to the network with information.

The ODN 120 distributes downstream data frames received from the OLT 110 into ONUs 132, 134 and 136. The ONUs 132, 134 and 136 receive downstream data frames, and transmit them to the user terminals 142, 144 and 146. At the same time, the ODN multiplexes upstream data frames received from the ONUs 132, 134 and 136, which receive the upstream data frames received from the user terminals 142, 144 and 146 to the OLT 110 over the ODN 120. Note that the user terminals 142, 144 and 146 represent a variety of network termination units available in the PON system.

As shown in FIG. 2, the Ethernet frames transmitted from the first user terminal 142 to the second user terminal 144 are transmitted only to the OLT 110, but are not transmitted to the second user terminal 144. In addition, the bridge connected to the OLT 110 does not transmit the Ethernet frames to the second user terminal 144 in downstream transmission, resulting in the loss of Ethernet frames. That is, due to the underlying conditions, as described earlier, the PON system implemented in a conventional bridge network results in frame loss.

Therefore, there is a need to develop a new scheme for allowing the PON to be compatible with a conventional bridge shown in FIG. 1 in order to perform a Peer-to-Peer (P2P) transmission in a conventional point-to-multipoint PON system.

### SUMMARY OF THE INVENTION

The present invention has been made to overcome the above problems and provides additional advantages, by providing an Ethernet frame structure that performs an emulation function to allow an Ethernet PON structure to be compatible with a conventional 802.1D bridge. The present invention further provides an Ethernet PON system using the Ethernet frame structure, and a point-to-point emulation implementation method for use in the Ethernet PON system.

In one embodiment, an Ethernet Passive Optical Network (EPON) system having an Optical Line Termination (OLT) and a plurality of Optical Network Units (ONUs) connected to the OLT for providing a Peer-to-Peer (P2P) transmission between ONU-side objects controlled by the OLT includes: a PON tagging Ethernet frame for the P2P transmission, including a Destination Address (DA) field, a SA Source Address (SA) field, a mode field indicating an emulation mode, and a PHY_ID field indicating identifiers (IDs) of the ONU-side objects, and a data field. The OLT further includes: a multiplexing layer for transmitting a received PON tagging Ethernet frame to an upper layer over a logic port connected to a corresponding PHY_ID field; and a bridging function layer for converting information of the PHY_ID field into PHY_ID information corresponding to a destination ONU-side object by referring to the DA field when an emulation mode of a frame received through the logic port is the P2P transmission mode and for transmitting the converted PHY_ID information to a corresponding ONU through a logic port associated with the converted PHY_ID information.

### BRIEF DESCRIPTION OF THE DRAWINGS

The above features and other advantages of the present invention will be more clearly understood from the following detailed description taken in conjunction with the accompanying drawings, in which:

FIG. 1 is a view illustrating a relationship between the IEEE 802.3 Ethernet and the IEEE 802.1D bridge in accordance with a conventional art;

FIG. 2 is a block diagram of a conventional PON system;

FIG. 3 is a view illustrating a PON tagging Ethernet frame structure in accordance with a preferred embodiment of the present invention;

FIG. 4 is a view illustrating a PON tagging Ethernet MAC control frame structure for an Multi-Point Control Protocol (MPCP) in accordance with a preferred embodiment of the present invention;

FIG. 5 is a view illustrating a PON tagging Ethernet MAC control frame structure for pausing an Ethernet PON system in accordance with a preferred embodiment of the present invention;

FIG. 6 is a view illustrating an Ethernet PON system configuration in accordance with a preferred embodiment of the present invention;

FIG. 7 is a view illustrating a layer transmission structure for a PON tagging Ethernet frame in the OLT shown in FIG. 6 in accordance with a preferred embodiment of the present invention;

FIG. 8 is a view illustrating a layer transmission structure for a PON tagging Ethernet MAC control frame used for the MPCP in the OLT shown in FIG. 6 in accordance with a preferred embodiment of the present invention;

FIG. 9 is a view illustrating a layer transmission structure for a PON tagging Ethernet MAC control frame for tagging the Ethernet frame in the OLT shown in FIG. 6 in accordance with a preferred embodiment of the present invention; and

FIGS. 10 and 11 illustrate an overall operation of a bridge function layer in accordance with a preferred embodiment of the present invention.

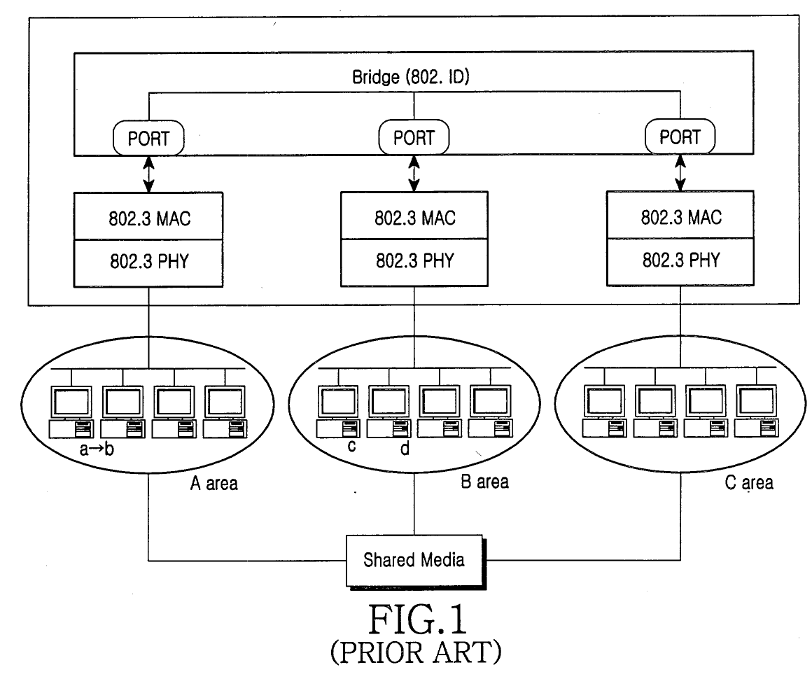

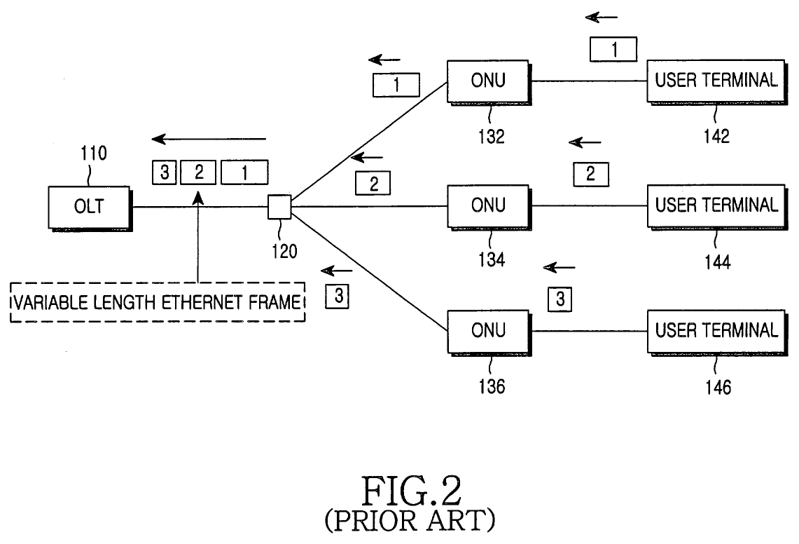

### DETAILED DESCRIPTION OF THE PREFERRED EMBODIMENTS

Now, preferred embodiments of the present invention will be described in detail with reference to the annexed drawings. In the drawings, the same or similar elements are denoted by the same reference numerals even though they are depicted in different drawings. For the purposes of clarity and simplicity, a detailed description of known functions and configurations incorporated herein will be omitted as it may make the subject matter of the present invention rather unclear.

According to the teachings of the present invention, T an extra field of “vLink” tag is added to the conventional Ethernet frame. The “vLink” tag includes a mode field of 1 bit and a PHY_ID field of 15 bits. The mode field is classified into a P2P mode field and a Single Copy Broadcasting (SCB) mode field depending on the type of emulation modes. If necessary, additional modes may be further defined. The P2P mode is adapted to perform a P2P transmission in the Ethernet PON system, and the SCB mode is adapted to transmit frames to other ONUs other than the ONU that is transmitting the frame. The PHY_ID field is adapted to represent individual ONUs, or is assigned to indicate user ports connected to the individual ONUs. The PHY_ID field is adapted to identify the individual objects contained in a PON system, which is controlled by an OLT. The Ethernet frame having the “vLink” tag field will herein be called a PON tagging Ethernet frame.

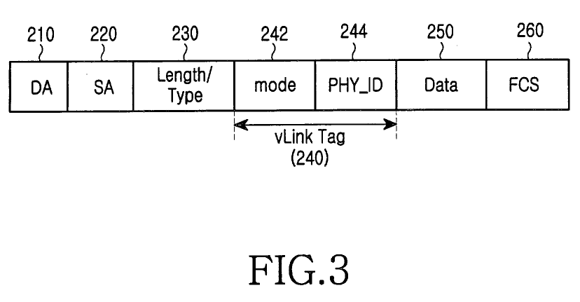

FIG. 3 is a view illustrating the PON tagging Ethernet frame structure in accordance with a preferred embodiment of the present invention. As shown, the PON tagging Ethernet frame includes a Destination Address (DA) field 210, a Source Address (SA) field 220, a length/type field 230, a mode field 242, a PHY_ID field 244, a data field 250, and a Frame Check Sequence (FCS) field 260. The PON tagging Ethernet frame inserts the mode field 242 and the PHY_ID field 244 between the length/type field 230 and the data field 250 compared to a conventional Ethernet frame structure. A payload data unit (PDU) for each user is connected successively to the rear of the PHY_ID field 244.

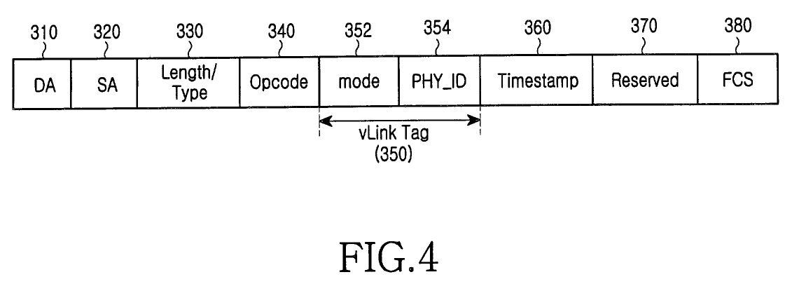

FIG. 4 is a view illustrating a PON tagging Ethernet MAC control frame structure for an MPCP in accordance with a preferred embodiment of the present invention. As shown, the PON tagging Ethernet MAC control frame includes a DA field 310, a SA field 320, a length/type field 330, an OP code field 340, a mode field 352, a PHY_ID field 354, a timestamp field 360, a reserved field 370, and a FCS field 380. The PON tagging Ethernet MAC control frame for use in the MPCP inserts the mode field 352 and the PHY_ID field 354 between the OP code field 340 and the timestamp field 360 compared to a conventional Ethernet frame structure. The OP code field 340 is adapted to define a new OP code for performing the MPCP of the Ethernet PON system. The mode field 352, the PHY_ID field 354, and the timestamp field 360 correspond to OP code parameters. As the reserved field 370 is set differently according to the detailed functions of the MPCP message, it remains null generally.

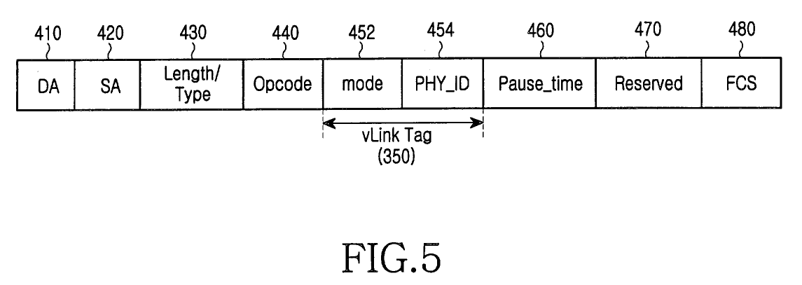

FIG. 5 is a view illustrating a PON tagging Ethernet MAC control frame structure for pausing an Ethernet PON system in accordance with a preferred embodiment of the present invention. As shown, the PON tagging Ethernet MAC control frame includes a DA field 410, a SA field 420, a length/type field 430, an OP code field 440, a mode field 452, a PHY_ID field 454, a Pause_time field 460, a reserved field 470, and a FCS field 480. The PON tagging Ethernet MAC control frame inserts the mode field 452 and the PHY_ID field 454 between the OP code field 440 and the Pause_time field 460 of a conventional Ethernet frame structure. The OP code field 440 is adapted to define a new OP code for pausing the Ethernet PON system. The mode field 452, the PHY_ID field 454, and the Pause_time field 460 correspond to OP code parameters.

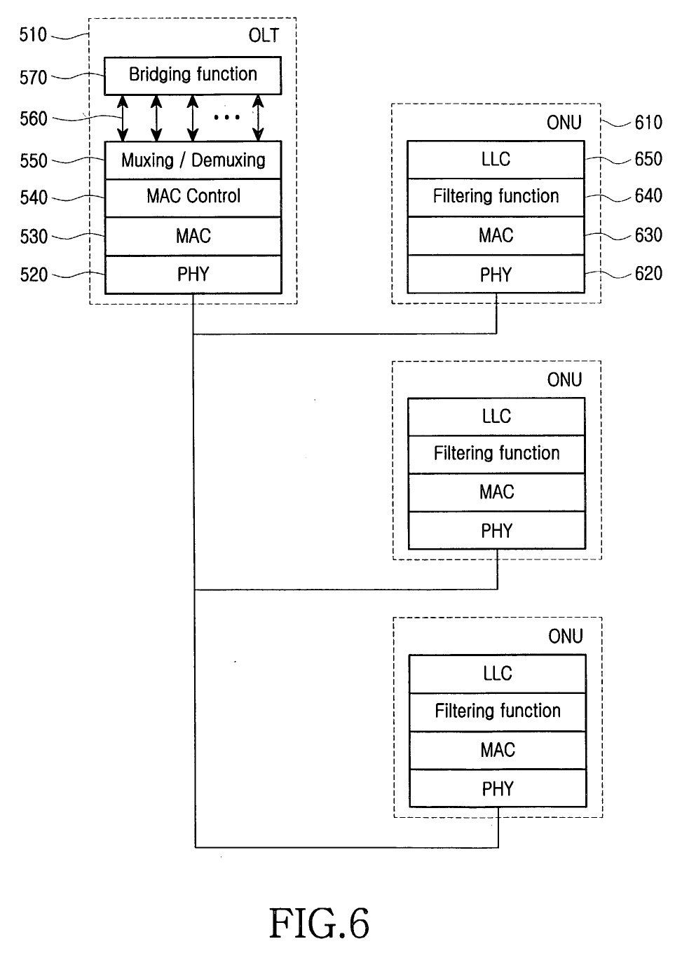

FIG. 6 is a view illustrating an Ethernet PON system configuration in accordance with a preferred embodiment of the present invention. The Ethernet PON system includes a single OLT 510 and a plurality of ONUs 610 connected to the OLT 510 in the form of a tree topology. The ONU 610 includes 802.3 PHY layer 620, 802.3 MAC layer 630, a filtering function layer 640, and a LLC layer 650. In this case, the ONU 610 adds the filtering layer 640 to a conventional ONU layer structure, and the function of the filter layer 640 will be described in detail hereinafter.

In the case of receiving a PON tagging Ethernet frame from the OLT 510, the filtering layer 640 checks the mode field. If the mode field indicates a SCB mode and a value of a PHY_ID field of the received frame is identical with a value of a PHY_ID field of the filtering layer 640, the received PON tagging Ethernet frame is discarded. However, if the value of the PHY_ID field of the checked frame is different from the value of the PHY_ID field of the filtering layer 640, the filtering layer 640 receives this PON tagging Ethernet frame. That is, if the PHY_ID value of the received frame is identical with the PHY_ID value of the filtering layer 640, this reception frame is considered to be a frame transmitted at the SCB mode by the filtering layer 640, such that the filtering layer 640 filters out this reception frame.

On the other hand, if the mode of a received frame is a P2P mode and a value of a PHY_ID field of the checked frame is identical with a value of a PHY_ID field of the filtering layer 640, the filtering layer 640 receives this PON tagging Ethernet frame. However, if the value of the PHY_ID field of the checked frame is different from the value of the PHY_ID field of the filtering layer 640, this PON tagging Ethernet frame is discarded. That is, in the case where the value of the PHY_ID field of the received frame is different from that of the filtering layer 640, it is determined that this received frame is not directed to the filtering layer 640, such that this frame is filtered.

The OLT 510 includes a 802.3 PHY layer 520, a 802.3 MAC layer 530, a 802.3 MAC control layer 540, a multiplexing layer 550, and a bridging function layer 570. In this case, the OLT 510 further includes the multiplexing layer 550 and the bridging function layer 570 compared to a conventional OLT layer structure, and the function of these layers will be described in detail hereinafter.

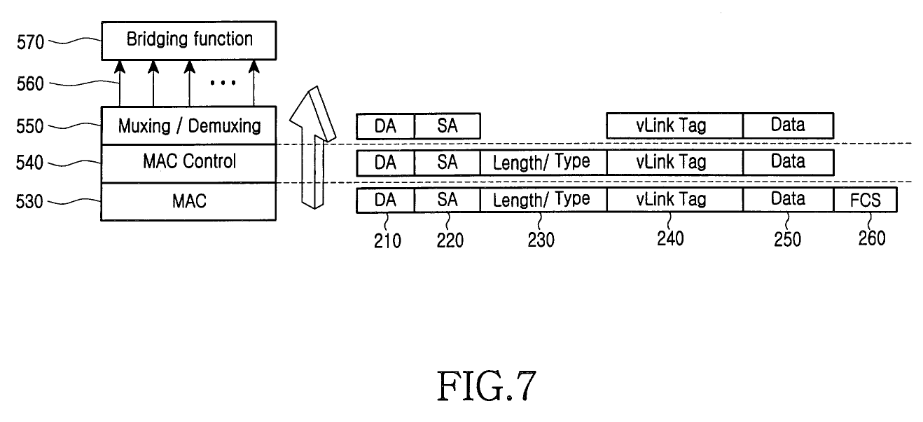

FIGS. 7 to 9 illustrate encapsulation/decapsulation structures associated with the individual frame layers of the OLT 510, and they are denoted by the frame transmission direction from the ONU 610 to the OLT 510.

FIG. 7 is a view illustrating a layer transmission structure of a PON tagging Ethernet frame (shown in of FIG. 3) in the OLT 510 (shown in FIG. 6) in accordance with a preferred embodiment of the present invention. Referring to FIG. 7, the frame transmitted to the PHY layer 520 performs basic operations in the MAC layer 530, and then the DA field 210, the SA field 220, the length/type field 230, the vLink tag field 240, and the data field 250 are transmitted to an upper layer. Upon receiving the frame from the PHY layer 520, the MAC control layer 540 first checks the length/type field 230. In this case, the above frame is a user frame, such that the length/type field 230 indicates a frame length. If the frame is a user frame, the MAC control layer 540 performs no operation and transmits the DA field 210, the SA field 220, and the data field 250 to the upper layer. In this case, the vLink tag field 240 is considered to be a user data field, thus transmitted to the upper layer along with the fields 210, 220, and 250.

Thereafter, the multiplexing layer 550 checks the vLink tag field 240, and transmits the DA field 210, the SA field 220, the vLink tag field 240, and the data field 250 to the upper layer over a logic port 560 connected to a corresponding PHY_ID field. Upon receipt, the bridging function layer 570 combines MAC address information of the DA field 210 and the SA field 220 with the mode and PHY_ID information of the vLink tag field 240, and performs a reflection or forwarding operation according to the combined result. Note that the vLink tag field 240 has different PHY_ID values according to individual modes. If the mode is a P2P mode, a PHY_ID value indicating a destination address is allocated to the vLink tag field 240. If the mode is a SCB mode, a PHY_ID value of the ONU used for transmitting the frame to the OLT 510 is allocated to the vLink tag field 240. This PHY_ID allocation method is applicable in the same in downstream transmission.

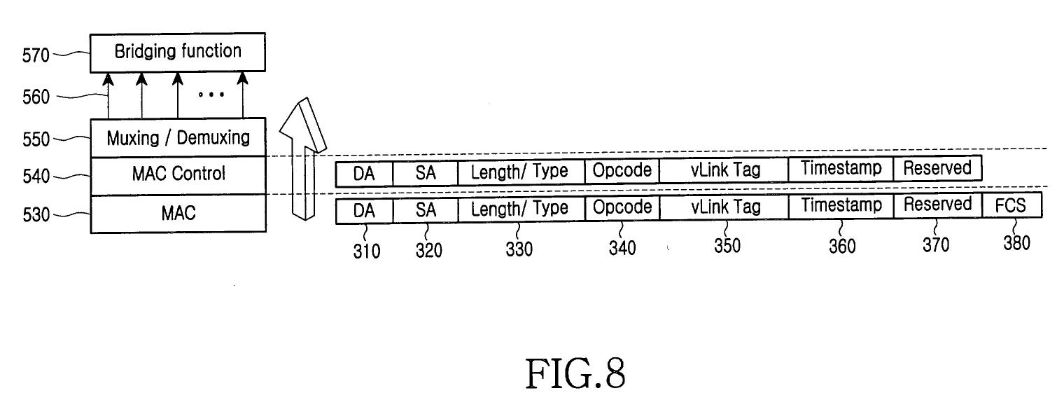

FIG. 8 is a view illustrating a layer transmission structure for a PON tagging Ethernet MAC control frame used for the MPCP in the OLT 510 shown in FIG. 6 in accordance with a preferred embodiment of the present invention. The Ethernet PON system implements an Ethernet PON's MPCP function using a MAC control frame. The MAC control layer 540 receives fields from the MAC layer 530 and then checks the length/type field 330. In this case, the length/type field 330 functions as a type field and the value of the type field indicates a MPCP definition value, so that the next fields are determined to be OP code parameters for the MPCP. The MAC control layer 540 of the OLT 510 checking the MPCP type may operate differently according to the individual ONUs 610 using the vLink tag field 350 and the timestamp field 360. The MAC control layer 540 also performs a ranging function, an automatic discovery function (also known as an auto discovery function), and a DBA function that are common in the MPCP operations. In this case, the PHY_ID value of the vLink tag field 350 is the same as a PHY_ID value assigned to an ONU for transmitting the frame to the OLT 510 in upstream transmission. In the case of downstream transmission, the PHY_ID value of the vLink tag field 350 is the same as a PHY_ID value of a destination ONU receiving the above frame.

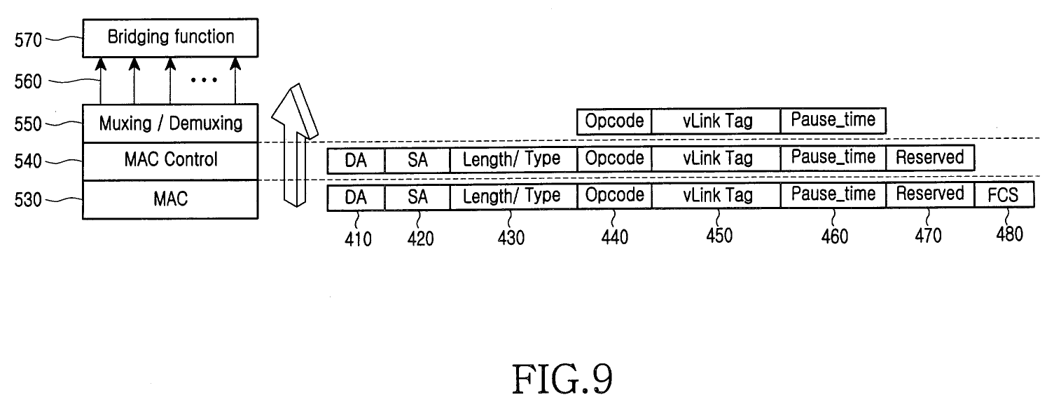

FIG. 9 is a view illustrating a layer transmission structure for a PON tagging Ethernet MAC control frame for pausing the Ethernet PON system in the OLT 510 shown in FIG. 6 in accordance with a preferred embodiment of the present invention. According to the conventional Ethernet MAC control frame for pausing the Ethernet PON system, it is impossible for the OLT 510 to pause the Ethernet PON system according to the individual ONUs 610 or individual subjects of the vLink tag. Therefore, the present invention can overcome this problem by adapting the vLink tag field 450 as an OP code parameter.

In operation, the MAC control layer 540 transmits a DA field 410, an OP code field 440, a vLink tag field 450, a Pause_time field 460 to an upper layer. The multiplexing layer 550 receiving them confirms the Ethernet PON pause state by referring to the OP code, checks information of the vLink tag field 450 and the Pause_time field 460, and then transmits the checked information to the bridging function layer 570 over a logic port 560. The bridging function layer 570 disables the logic port 560 of a corresponding vLink tag during a predetermined pause time, thereby implementing the Ethernet PON pause function. In the case of upstream transmission in such Ethernet PON pause state, the PHY_ID value of the ONU transmitting the above frame is the same as a PHY_ID value of the vLink tag field 450. In the case of downstream transmission, the PHY_ID value of the OLT 510 is defined as a default ID value and is then assigned. However, a DBA (Dynamic Bandwidth Allocation) activated in the OLT 510 performs the same function as an Ethernet PON pause function, such that the PON tagging Ethernet MAC control frame for pausing the upstream Ethernet PON system may be ineffective as OLT control the transmission time and length of ONU by DBA

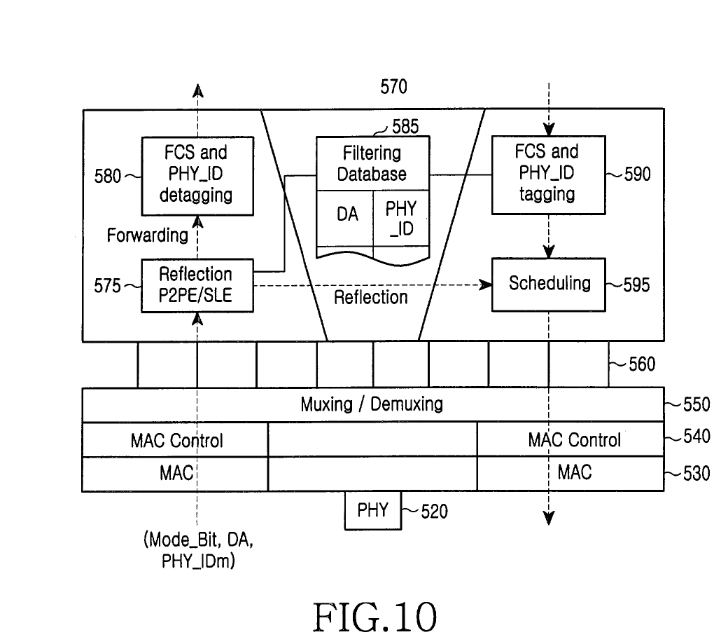

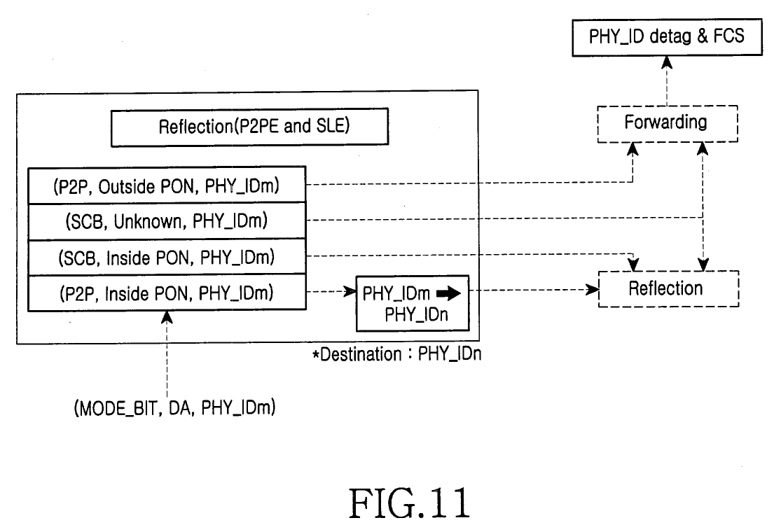

FIGS. 10 and 11 illustrate an overall operation of a layer having a bridge function layer in accordance with a preferred embodiment of the present invention. The bridging function layer 570 processes information received from MAC control layer 540 differently according to the type of frames, such as a general frame or a control frame. If the information received from the MAC control layer 540 indicates the general frame (i.e., a general data frame), information of the PHY_ID and DA fields of the vLink tag field is checked first to determine either (1) whether a destination address exists in a corresponding PON system, or (2) whether the OLT 510 recognizes the destination.

If it is determined that the destination exists in the inside of the PON system, the OLT 510 checks a mode field. If it is determined that a mode is a SCB mode, the frame is transmitted to the logic port 560 associated with a corresponding PHY_ID information. If it is determined that a mode is a P2P mode, the OLT 510 converts information of the PHY_ID field into PHY_ID information associated with the destination ONU by referring to the DA fields, and then transmits the converted information to the reflection field 575. The frame transmitted to a corresponding logic port 560 after passing a plurality of fields from the reflection field 575 to the scheduler field 595 is transmitted in downstream transmission.

If the OLT 510 recognizes the destination, the information received from the MAC control layer 540 is reflected at a reflection field 575 and then transmitted to a scheduler 595. If the destination exists in the outside of the PON system or does not exist in a filtering database (DB) 585 of the OLT 510, the received information is broadcast and then forwarded to a desired destination.

Having thus described a preferred embodiment of a system for transmission communications in the Ethernet Passive Optical Network (EPON) system, it should be apparent to those skilled in the art that certain advantages of the system have been achieved. As apparent from the above description, the Ethernet PON system according to the present invention uses a PON tagging Ethernet frame having the vLink tag field and includes a multiplexing layer and a bridging function layer that are adapted to process this PON tagging Ethernet frame to an OLT, such that the Ethernet PON media can be connected to a bridge without changing a conventional 802.1D bridge.

While the preferred embodiments of the present invention have been illustrated and described, it will be understood by those skilled in the art that various changes and modifications may be made, and equivalents may be substituted for elements thereof without departing from the true scope of the present invention. In addition, many modifications may be made to adapt to a particular situation and the teaching of the present invention without departing from the central scope. Therefore, it is intended that the present invention not be limited to the particular embodiment disclosed as the best mode contemplated for carrying out the present invention, but that the present invention include all embodiments falling within the scope of the appended claims.

What is claimed is:

1. An Ethernet Passive Optical Network (EPON) system having an Optical Line Termination(OLT) and a plurality of Optical Network Units (ONUs) connected to the OLT for providing a Peer-to-Peer(P2P) transmission between ONU-side objects controlled by the OLT, comprising:
a PON tagging Ethernet frame including a Destination Address (DA) field, a SA (Source Address) field, a mode field indicating an emulation mode, and a PHY_ID field indicating identifiers (IDs) of the ONU-side objects, and a data field.

2. The EPON system as set forth in claim 1, wherein the OLT further includes:
a multiplexing layer for transmitting the PON tagging Ethernet frame received therein to an upper layer over a logic port associated with the corresponding PHY_ID field; and
a bridging function layer for converting information of the PHY_ID field into PHY_ID information corresponding to a destination ONU-side object by referring to the DA field when an emulation mode of a frame received through the logic port is the P2P transmission mode, and for transmitting the converted PHY_ID information to a corresponding ONU over a logic port associated with the converted PHY_ID information.

3. The EPON system as set forth in claim 1, wherein the bridging function layer transmits a frame to the ONUs over the logic port associated with the corresponding PHY_ID field, while maintaining the information of the PHY_ID field if the emulation mode is a SCB (Single Copy Broadcasting) mode.

4. The EPON system as set forth in claim 1, wherein the PON tagging Ethernet frame further includes a length/type field for indicating a frame length or a frame type, and wherein the PHY_ID field and the mode field are arranged between the length/type field and the data field.

5. The EPON system as set forth in claim 1, wherein the ONUs respectively include a filtering layer, the filtering layer is configured to check the mode field when receiving the PON tagging Ethernet frame from the OLT, to receive the frame when the checked mode is a P2P mode and information of the PHY_ID field is identical with PHY_ID information assigned to the filtering layer, and to discard the frame when the information of the PHY_ID field is different from the PHY_ID information assigned to the filtering layer.

6. The EPON system as set forth in claim 4, wherein the filtering layer discards the frame when the checked mode is a SCB mode and checked PHY_ID information is identical with PHY_ID information assigned to the filtering layer, and receives the frame when the PHY_ID information is different from PHY_ID information assigned to the filtering layer.

7. The EPON system as set forth in claim 1, wherein the mode field comprises 1 bit and the PHY_ID field comprises 15 bits.

8. An Ethernet Passive Optical Network (EPON) system having an Optical Line Termination (OLT) and a plurality of Optical Network Units (ONUs) connected to the OLT for providing a Multi-Point Control Protocol (MPCP) functions for each ONU, comprising:
a PON tagging Ethernet MAC control frame for MPCP, including a DA field, a SA field, a length/type field, an OP code field, a mode field indicating an emulation mode, a PHY_ID field indicating identifiers of the ONUs, and a timestamp field.

9. The EPON system as set forth in claim 8, wherein the OLT further includes:
a MAC control layer for performing a MPCP operation associated with a corresponding ONU using the PHY_ID field and the timestamp field when the length/type field of a received PON tagging Ethernet MAC control frame indicates an MPCP type;
a multiplexing layer for transmitting a frame received from the MAC control layer to an upper layer over a logic port associated with corresponding PHY_ID information; and
a bridging function layer for converting information of the PHY_ID field into PHY_ID information corresponding to a destination ONU by referring to a DA field of a frame received through the logic port, and for transmitting the frame to a corresponding ONU over a logic port associated with the converted PHY_ID information.

10. The EPON system as set forth in claim 8, wherein the mode field comprises 1 bit and the PHY_ID field comprises 15 bits.

11. An Ethernet Passive Optical Network (EPON) system having an Optical Line Termination (OLT) and a plurality of Optical Network Units (ONUs) connected to the OLT for providing Ethernet PON pause functions for each ONU, comprising:
an Ethernet MAC control frame for pausing an Ethernet PON, including a DA field, a SA field, a length/type field, an OP code field, a mode field indicating an emulation mode, a PHY_ID field indicating identifiers of the ONUs, and a pause_time field.

12. The EPON system as set forth in claim 11, wherein the OLT further includes:
a multiplexing layer for checking an OP code of the PON tagging Ethernet MAC control frame received therein, determining whether the checked OP code indicates an Ethernet PON pause state, and transmitting the frame to an upper layer over a logic port associated with corresponding PHY_ID information when the checked OP code indicates the Ethernet PON pause state; and
a bridging function layer for disabling the logic port receiving the frame during a pause time, and pausing the Ethernet PON.

13. The EPON system as set forth in claim 11, wherein the mode field comprises 1 bit and the PHY_ID field comprises 15 bits.
